(19) United States
(12) Patent Application Publication
(10) Pub. No.: US 2006/0136202 A1
(43) Pub. Date: Jun. 22, 2006

(54) Quantization of excitation vector

(75) Inventor: Anirban Sengupta, Bangalore (IN)

Correspondence Address: TEXAS INSTRUMENTS INCORPORATED, P O BOX 655474, M/S 3999, DALLAS, TX, 75265, US

(73) Assignee: Texas Instruments, Inc.

(21) Appl. No.: 11/300,924

(22) Filed: Dec. 15, 2005

Related U.S. Application Data
(60) Provisional application No. 60/636,726, filed on Dec. 16, 2004.

(51) Int. Cl. G10L 19/12

(52) U.S. Cl. 704/222

(57) ABSTRACT

A method is disclosed for performing excitation quantization of an input signal using a vector quantization codebook having a plurality of code-vectors, the codebook being associated with a filter system. The method can include determining filter states for the filter system independent of the codebook to define a codebook independent filter system. A quantization error vector for at least a portion of the code-vectors in the codebook is determined based at least in part on the codebook independent filter system. A winning code-vector from the codebook is selected based on predetermined criteria that is functionally related to the determined quantization error vector. The filter memory states of the filter system are updated using the selected winning code-vector.

### CROSS REFERENCE TO RELATED APPLICATION

This application claims the benefit of U.S. provisional patent application Ser. No. 60/636,726, which was filed Dec. 16, 2004, and entitled SIMPLIFIED APPROACH TO EXCITATION QUANTIZATION IN BROADVOICE 16, which is incorporated herein by reference.

### TECHNICAL FIELD

This invention generally relates to signal processing and, more particularly to quantization of an excitation vector with reduced computational complexity.

### BACKGROUND

Various approaches exist for transmitting information or data from an information source to one or more intended destinations. A digital communication system is designed to transmit information in digital form, regardless of whether the information source is analog or digital. In order to transmit the information in digital form, the output signal from the information source is encoded for transmission over a communication channel (e.g., wireless or wire, optical fiber or other media).

One type of encoding relates to encoding an analog source by quantization of a corresponding analog output signal. Block or vector quantization, which is widely used in speech coding, involves a joint quantization of a block of signal samples or a block of signal parameters. This can be contrasted with scalar quantization, which performs quantization on a sample-by-sample basis. By quantizing vectors instead of scalars, improved performance can be achieved, especially in cases when there are some statistically dependent parameters in the signal samples.

In the realm of vector quantization, significant research has been devoted to encoding speech signals as speech encompasses one of the largest parts of daily communications. To facilitate encoding and decoding speech, model-based speech codecs (code-decoders) are often employed to achieve communication quality speech at low bit rates. As a further example, code-excited linear predictive coding (CELP) and vector-sum-excited linear predictive coding (VSELP) utilize vector-quantized excitation codebooks for encoding and decoding speech. While many existing methods may facilitate the digital transmission of quality speech, differences between such approaches generally reside in their respective transmission rates and the computation complexity associated with quantization and encoding the speech signals.

### SUMMARY

The present invention relates to signal processing and, more particularly to quantization of an excitation vector with reduced computational complexity.

One embodiment provides a method for performing excitation quantization of an input signal using a vector quantization codebook having a plurality of code-vectors, the codebook being associated with a filter system. The method includes determining filter states for the filter system independent of the codebook to define a codebook independent filter system. A quantization error vector for at least a portion of the code-vectors in the codebook is determined based at least in part on the codebook independent filter system. A winning code-vector from the codebook is selected based on predetermined criteria that is functionally related to the determined quantization error vector. The filter memory states of the filter system are updated using the selected winning code-vector.

Another embodiment of the present invention provides a system for performing excitation quantization of an input signal. The system includes means for determining a codebook independent filter having filter states that are independent of an associated scaled codebook. The system also includes means for determining a winning code-vector candidate from a plurality of code-vector candidates in the codebook based on predetermined criteria that evaluates the code-vector candidates using the codebook independent filter. The system also includes means for updating filter memory with filter states determined based on the winning code-vector candidate.

Yet another aspect of the present invention provides a system that includes a filter system associated with a scaled codebook that has a plurality of code-vectors, the filter system having filter parameters that define respective filter states in corresponding filter memory. A codebook search having a first component that configures the filter system independently of the codebook for a given input signal and updates the filter memory to define a codebook independent filter system having corresponding codebook independent filter states. The codebook search has a second component that updates the filter memory with a second set of filter states based on a winning code-vector that is selected from the scaled codebook to substantially minimize energy of a quantization error vector of the filter system. At least a portion of the quantization error vector being determined as a function of the codebook independent filter system.

### BRIEF DESCRIPTION OF THE DRAWINGS

FIG. 1 illustrates an example of a system for performing excitation quantization in accordance with an aspect of the invention.

FIG. 2 is a block diagram illustrating a conventional filter system that is utilized for performing excitation quantization codebook search.

FIG. 3 illustrates a block diagram of a filter system that can be utilized for performing a first portion of a codebook search in accordance with an aspect of the invention.

FIG. 4 illustrates a second portion of an approach for performing excitation quantization in accordance with an aspect of the invention.

FIG. 5 illustrates a functional block diagram of a system that can be employed to update filter memory states in accordance with an aspect of the invention.

FIG. 6 illustrates an example of a method for performing an excitation vector quantization codebook search in accordance with an aspect of the invention.

### DETAILED DESCRIPTION

The present invention relates generally to systems and methods that can be employed to quantize an excitation vector with reduced computation complexity when such quantization involves employs a codebook. The approach achieves reduced complexity by separating filtering operations and associated computations into a code-vector independent portion and a code-vector dependent portion. For instance, the code-vector independent portion can be implemented outside the core search loop for a winning code-vector.

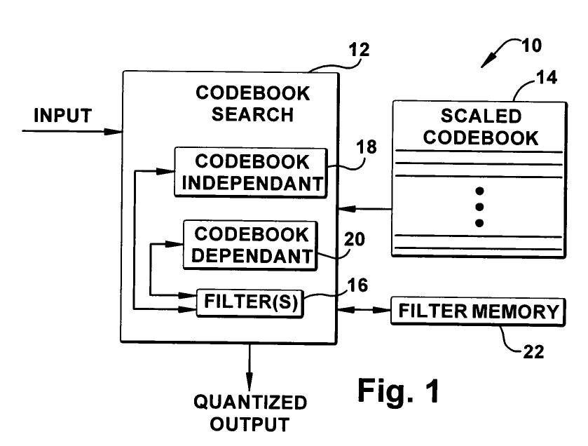

FIG. 1 depicts a system 10 that performs excitation quantization according to an aspect of the present invention. The system 10 includes a codebook search 12 that is programmed and/or configured to quantize an INPUT signal. The codebook search 12 selects a winning scaled code-vector candidate based on a set of code-vector candidates provided by a pre-computed scaled codebook 14. The codebook search provides a corresponding quantized output, which corresponds to quantized version of the INPUT signal, according to the winning code-vector candidate.

The codebook search 12 includes one or more filters 16 that include noise feedback. As an example, the one or more filters 16 can be implemented as including short term noise prediction, short term spectral shaping as well as long term noise prediction and long term spectral shaping. Those skilled in the art will understand various types and configurations of filters 16 that can be implemented as part of the system 10. At least a portion of the feedback performed by the filters results in feedback that is dependent on the scaled code-vector.

In order to simplify the computational complexity of the filtering that is employed by the search 12 for the winning code-vector candidate, the codebook search 12 separates the filtering operations into two components: (i) a codebook independent component 18 and (ii) a codebook dependent component 20. The codebook independent component 18 employs the one or more filters 16 to perform filtering operations on the INPUT signal and associated computations that are independent of the scaled codebook 14. The codebook independent component 18 thus provides means for determining a codebook independent filter having filter states that are independent of an associated scaled codebook 14. The codebook dependent component 20 employs the one or more filters 16 to perform other filtering operations and computations that are dependent on the scaled codebook. As described below, the codebook dependent component 20 can further depend on the filtering operations and computations implemented by the codebook independent component 18. The codebook dependent component 20 thus means for determining a winning code-vector candidate from the code-vector candidates in the codebook 14 based on predetermined criteria that evaluates the code-vector candidates using the codebook independent filter. The codebook search further provides

The one or more filters 16 have filter states that are defined by values stored in filter memory 22. The filter memory 22, for example, can be random access memory (e.g., dynamic or static RAM) that stores filter values for each of the one or more filters 16. The set of filter values may vary according to the type of filter and the filter function being performed. For instance, a short term filter can store filter values in the memory 22 corresponding to filter values for a predetermined number of one or more prior samples (e.g., eight samples). A long term filter can store filter values in memory over a greater predetermined number of prior samples (e.g., sixteen samples) than the short term. Those skilled in the art will understand that the number samples used to define the filter memory states stored for a given filter and the length of filter memory can vary according to design requirements and available memory in the system.

By way of example, the codebook independent component 18 can be programmed and/or configured to determine one or more codebook independent filters 22. For instance, the codebook independent filters can be determined by ignoring (e.g., setting equal to zero) the scaled code-vectors from the codebook 14. In the absence of the code-vectors from the codebook 14, a set of codebook independent filter states can be ascertained, which can be used to update the corresponding filter memory 22. The codebook independent component 18 filters the scaled codebook through the codebook independent filter to define a corresponding filtered scaled codebook. The filtered scaled codebook thus includes scaled code-vectors that are themselves codebook independent. The codebook independent component 18 can also determine a codebook independent component of a quantization error vector based on filtering the INPUT through the codebook independent filters. The codebook dependent component 20 can then utilize the codebook independent component of a quantization error vector and the filtered scaled codebook to determine a quantization error vector for each of the scaled code-vectors in the codebook 14. The scaled code-vector that minimizes the energy of the quantization error corresponds to the best estimate or winning candidate for a given INPUT. The codebook search 18 can be configured as means for calculating the energy of the quantization error vector for each of the plurality of code-vector candidates. The code book search 18 can also provide means for selecting the winning code-vector candidate according to which of the plurality of code-vector candidates minimizes the energy of the quantization error vector.

As an example, the values of the filters for the winning scaled code-vector candidate can be combined with the respective filter values for the codebook independent filters to define new aggregate filter memory values. The codebook search 12 employs the new filter memory values to update the respective filter memories 22. For instance, when a particular short term filter states are updated in the memory 22, the new filter state values are shifted into a portion of the memory block for that particular filter. The codebook search 12 thus provides means for updating filter memory 22 with filter states determined based on the winning code-vector candidate.

The segregation of the filtering operations into codebook dependent and codebook independent components 18 and 20 affords reduced computational complexity when compared with a more traditional search. This is because the traditional approach requires that all filtering operations and associated computations be repeated for each code-vector as part of the core search loop. In contrast, the approach described herein need only perform the operations that are dependent on the codebook in the core search loop. Thus, by separating the filtering operations in the manner described herein, a significantly fewer number of operations are performed within the core search loop.

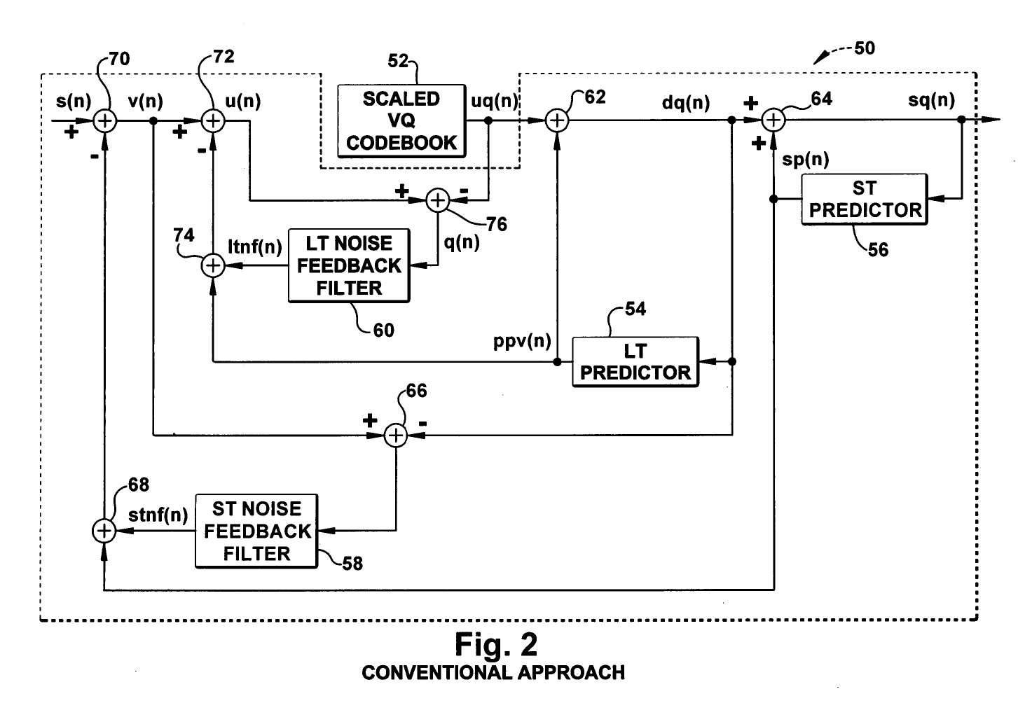

By way of context, FIG. 2 depicts an example of a traditional filter system 50 that can be utilized for performing a search of a scaled codebook 52 for quantization of an excitation vector. As mentioned above, the traditional approach for performing excitation quantization is to perform a search for a winning code-vector by driving the filter system 50 with each code-vector to determine a corresponding quantization error vector q(n). The process is repeated for each of the code-vectors and a winning candidate is selected based on predetermined criteria, such as corresponding to the scaled code-vector that minimizes the energy of the quantization error vector q(n).

In the particular example of FIG. 2, the filter system 50 includes a plurality of filters 54, 56, 58 and 60. For instance, the filter 54 corresponds to a long term predictor that performs pitch prediction to provide a corresponding pitch predictor vector ppv(n). For example, the pitch predictor vector ppv(n) can be represented as follows:

$$ppv ( n ) = {\sum }_{i = 1}^{3} {b}_{i} dq ( n - pp + 1 - i ) , n = 1 , 2 , 3 , 4 \qquad Eq . 1$$

where
bᵢ=the i^{th} long-term filter coefficient
n=sample index
dq=quantized version of short-term prediction residual signal; and
pp=pitch period
The set of long term filter coefficients [b₁, b₂, b₃] can be pre-computed according to the configuration of the respective filter 54. A combiner 62 determines the quantized short-term prediction residual vector dq(n) by summing together ppv(n) with the scaled code-vector, uq(n), such as can be represented as follows:
dq(n)=uq(n)+ppv(n), n=1, 2, 3, 4 Eq. 2
Then the short term predictor 56 can compute a short term predicted speech vector sp(n) as a function of the quantized speech vector sq(n) such as follows:

$$sp ( n ) = {\sum }_{i = 1}^{k} {\tilde{a}}_{i} sq ( n - i ) \qquad Eq . 3$$

where k=number of samples used for short term prediction filter 56 (e.g., k=4); and
\tilde{α}ᵢ=the i^{th} short term predictor coefficient
A combiner 64 determines the quantized speech vector sq(n) by summing the short term predicted speech vector sp(n) with the quantized residual signal dq(n), such as follows:
sq(n)=dq(n)+sp(n), for n=1, 2, 3, 4 Eq. 4

The filter system 50 also includes noise feedback filters 58 and 60. The filter 58 corresponds to a short term noise feedback filter that is configured to produce a short term noise feedback vector stnf(n). A combiner 66 drives the filter 58 with an input corresponding to the difference between an unquantized short-term residual signal vector v(n) and the quantized short-term residual vector dq(n). The short term noise feedback vector stnf(n) thus can be computed as follows:

$$stnf ( n ) = {\sum }_{i = 1}^{k} {β}_{i} [ v ( n - i ) - dq ( n - i ) ] - {\sum }_{i = 1}^{k} {α}_{i} stnf ( n - i ) \qquad Eq . 5$$

The unquantized short-term residual signal vector v(n) can be computed in two parts. A combiner 68 combines the short term noise feedback vector stnf(n) with the with the quantized short-term residual signal dq(n) to produce a first term. A second combiner 70 determines v(n) by subtracting the output of the combiner 68 from the unquantized input signal s(n). The unquantized short-term residual signal vector v(n), for example, can be expressed as follows:
v(n)=s(n)−sp(n)−stnf(n), for n=1, 2, 3, 4 Eq. 6

A combiner 72 determines an unquantized excitation vector u(n) by subtracting a long-term signal component from the unquantized short-term residual signal vector v(n). In the example of FIG. 2, the long-term noise feedback filter 60 computes a long-term noise feedback vector Itnf(n) as a function of an error vector q(n) which corresponds to the error between the unquantized excitation vector and the quantized excitation vector uq(n) provided by the scaled codebook 52. A combiner 74 sums ppv(n) with Itnf(n) to provide the long-term signal component that the combiner 72 subtracts from the unquantized short-term residual signal vector v(n) to produce u(n). Another combiner 76 determines the quantization error vector q(n). It can be shown that q(n) can be expressed as follows:
q(n)=v(n)−ppv(n)−λq(n−pp)−uq(n), for n=1, 2, 3, 4 Eq. 7

As mentioned above, the goal of the search procedure is to identify a scaled code-vector candidate uq(n) from the codebook 52 based on predetermined criteria. As but one example, the criteria can be the candidate that minimizes the energy of the quantization error vector q(n). The quantization error for a given code-vector can be expressed as follows:

$${E}_{q} = {\sum }_{n = 1}^{l} {q}^{2} ( n ) , \qquad Eq . 8$$

where 1 denotes the number of samples for a given code-vector (e.g., n=4).

From above, it is evident that equations 3, 4, 5, 6 7 and 8 depend on dq(n), which is in turn dependent on uq(n) (as per Eq 2). Since the scaled code-vector uq(n) drives the filter system (e.g., the filters and computations are dependent on uq(n)), such computations have to be performed inside the search loop to ascertain a winning code-vector for updating the associated filter memories.

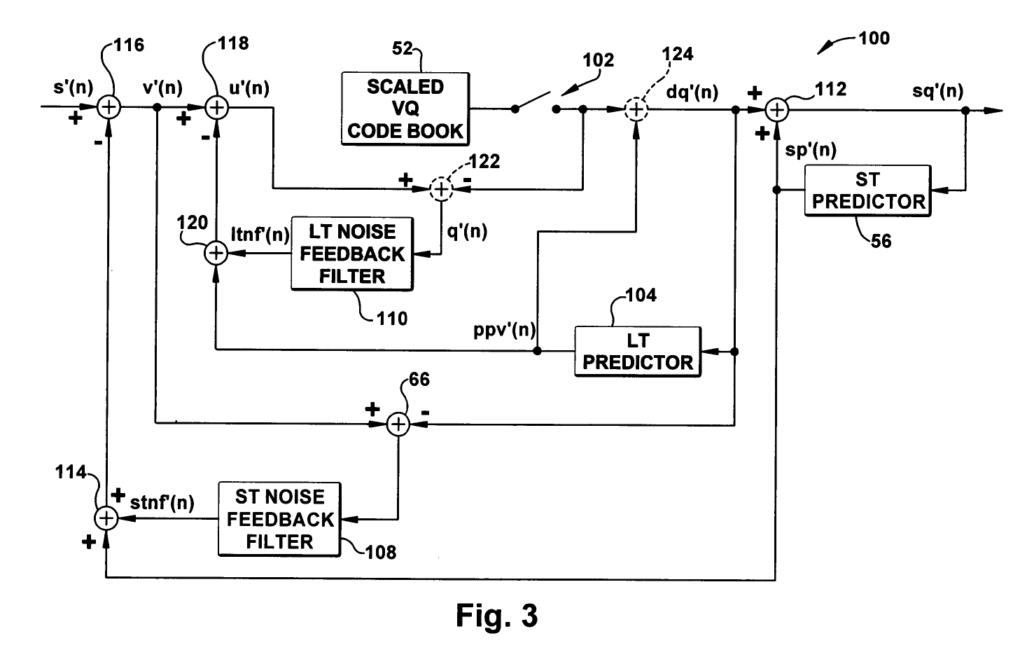

FIG. 3 depicts a block diagram of an example filter system 100 in accordance with an aspect of the present invention. The filter system 100 is utilized as part of search process for selecting a winning scaled code-vector uq(n) from the scaled codebook 52. For purposes of context, the filter system 100 shows the scaled codebook 52 separated from the filter through an open switch, schematically depicted at 102. By way of comparison, it will be apparent that the filter system 100 has substantially same basic structure as the traditional filter system 50 shown and described with respect to FIG. 2. This is because the filter system 100 can be implemented to perform excitation quantization and determine filter states that are mathematically identical to the approach FIG. 2.

The filter system 100 includes one or more filters 104, 106, 108 and 110 arranged to perform two stages of noise feedback coding. However, the associated memories for the filters 104, 106, 108 and 110 are updated independently of the scaled codebook 52, such that each of the respective filtering operations and computations can be more easily performed according to an aspect of the present invention. That is, the filter system 100 is codebook independent, such that the filtering operations and computations can be performed outside of the core search loop. For purposes of nomenclature, the codebook independent variables and filter states computed by the filter system 100 are denoted by including a prime symbol (“′”).

It will be understood and appreciated that the arrangement and configuration of the filter system 100 can be different from that shown and described herein, as any of a number of filter structures can be employed. For example, the filter system 100 may be implemented as a single stage of noise feedback coding or include multiple stages of noise feedback coding as shown in FIG. 3. Those skilled in the art will understand and appreciate other filter structures that could be utilized as the codebook independent filter system 100, such as may vary according to the particular codec being implemented and the design requirements of the excitation quantization and configuration of the codebook 52. During excitation quantization, each of the respective filters 104, 106, 108 and 110 may initialize to zeros (or other starting values) for the first frame of the input vector s(n) that is input to the filter system 100. For each subsequent frame, the respective filters 104, 106, 108 and 110 can start at the filter states that existed when the previous frame ended. Each frame can include a plurality of subframes. For purposes of simplicity of explanation, the filter system 100 will be described in terms of its application to a subframe that includes plural n samples (e.g., n=4).

Turning to the filter system 100 of FIG. 3, the filter memories of the respective filters 104, 106, 108 and 110 are updated based on the codebook independent short term residual vector dq′(n). In the codebook independent filter system 100 of FIG. 3, it is evident that (in the absence of scaled code-vector), dq′(n) can be expressed as
dq′(n)=ppv(n) Eq. 9

where ppv(n)=pitch period vector provided by the long term predictor filter 104.

Thus, for a given input signal s(n) and the dq′(n), the filter memories for the filter system 100 can be updated to provide corresponding codebook independent filter states. For example, dq′(n) and the input vector s(n) (e.g., corresponding to a subframe) can be passed through the filters 52, 54, 56 and 58, as provided by Eqs. 3, 4, 5, 6 and 7, to generate corresponding codebook independent filter states, indicated at sq′(n), stnf′(n), v′(n), and q′(n). The filter memories for the respective filters 104, 106, 108 and 110 are updated according to these codebook independent filter states.

Coefficients are determined for the codebook independent filter system 100, which coefficients can be derived based on the filter coefficients that are pre-computed for the traditional filter system 50. For instance, from the foregoing discussion for the filter system 50, aᵢ is the short term predictor coefficient, and αᵢ and βᵢ are short term noise feedback coefficients. It can also be shown that the quantization error vector q(n) can be expressed as follows:

$$\begin{matrix}q ( n ) = {q}^{′} ( n ) - {uq}^{′} ( n ) , for n = 1 , 2 , 3 , 4 \\ where \text{:} & Eq . 10 \\ {uq}^{′} ( n ) = uq ( n ) - {\sum }_{i = 2}^{n} {β}_{i}^{′} uq ( n - i + 1 ) , for n = 1 , 2 , 3 , 4 & Eq . 11\end{matrix}$$

The set of coefficients βᵢ′ defines a set of filter coefficients for the codebook independent filter system 100, which includes both short term predictor and short term noise feedback components. As an example, the set of coefficients βᵢ′ can be derived as a function of other codebook independent coefficients αᵢ′ and αᵢ′, such as follows:

$$\begin{matrix}\begin{matrix}{β}_{1}^{′} = 1 \\ {β}_{2}^{′} = - {a}_{2}^{′} - {α}_{2}^{′} \\ {β}_{3}^{′} = - {a}_{3}^{′} - {α}_{3}^{′} \\ {β}_{4}^{′} = - {a}_{4}^{′} - {α}_{4}^{′}\end{matrix} \} \\ where \text{:} & Eq . 12 \\ \begin{matrix}{α}_{1}^{′} = 1 \\ {α}_{2}^{′} = - {a}_{1} \\ {α}_{3}^{′} = - {a}_{2} + {a}_{1} {a}_{1} \\ {α}_{4}^{′} = - {a}_{3} + {a}_{1} {a}_{2} + {a}_{2}^{′} {a}_{3}^{′}\end{matrix} \} \\ and where \text{:} & Eq . 13 \\ \begin{matrix}{α}_{1}^{′} = 1 \\ {α}_{2}^{′} = - {β}_{1} \\ {α}_{3}^{′} = - {β}_{2} + {β}_{1} {β}_{2}^{′} - {α}_{1} {α}_{2}^{′} \\ {α}_{4}^{′} = - {β}_{3} + {β}_{2} {β}_{2}^{′} + {β}_{1} {β}_{3}^{′} - {α}_{2} {α}_{2}^{′} - {α}_{1} {α}_{3}^{′}\end{matrix} \} & Eq . 14\end{matrix}$$

Those skilled in the art will understand and appreciate that Eqs. 11, 12, 13 and 14 can be computed outside the core search loop since the coefficients and variables are independent of the scaled code-vector. That is, even though Eq. 11 includes the scaled code-vector uq(n), such terms are independent of the filter system, such that they can be computed outside the core search loop for the winning scaled code-vector candidate. As an example, assume that the scaled codebook 52 is implemented as a pre-computed gain scaled codebook of m candidates (m being a positive integer), in which the m/2 candidates consist of m independent code-vectors and their negated versions. In this example, Eq. 11 would only need to be computed for m/2 candidates, since the other m/2 candidates are corresponding negated versions.

As mentioned above, the codebook independent filter system 100 is implemented to reduce the computational complexity associated with identifying the winning scaled code-vector candidate from the scaled codebook 52 and updating the filter memory when compared to the traditional approach of FIG. 2. For purposes of simplicity of explanation, the following example assumes that the input vector s(n) is provided in frames that include 40 samples, which is sub-divided into 10 subframes of four samples (e.g., n=1, 2, 3, 4) per subframe. Thus, in this example, ten input vectors are quantized to determine respective winning scaled code-vector candidates. The winning candidate for each subframe is employed to update filter memory according to aspect of the present invention. The winning code-vector candidate uq(n) for a given subframe corresponds to the candidate that minimizes the energy of quantization error q(n), which from Eq. 8 can be expressed as follows:

$${E}_{q} = {\sum }_{n = 1}^{4} {q}^{2} ( n ) , for n = 1 , 2 , 3 , 4 \qquad Eq . 15$$

By substitution from Eq. 10 into Eq. 15, the energy Eq can be represented as follows:

$${E}_{q} = {\sum }_{n = 1}^{4} {q}^{′2} ( n ) + {\sum }_{n = 1}^{4} {uq}^{′2} ( n ) - 2 {\sum }_{n = 1}^{4} {q}^{′} ( n ) {uq}^{′} ( n ) \qquad Eq . 16$$

Eq. 16 thus demonstrates that the quantization energy includes three distinct elements. The first element of Eq. 16,

$${\sum }_{n = 1}^{4} {q}^{′ 2} ( n ) ,$$

is independent of the scaled code-vector and thus need not be computed as part of the search process. Optionally, this element can be computed outside the search loop that employs the codebook 52. The second element of Eq. 16,

$${\sum }_{n = 1}^{4} {uq}^{′ 2} ( n ) ,$$

can be pre-computed outside the search loop that employs the codebook 52, as described herein. As a result, the third element of Eq. 16,

$$2 {\sum }_{n = 1}^{4} {q}^{′} ( n ) {uq}^{′} ( n ) ,$$

corresponds to the only term that is computed inside the core search loop that involves the scaled codebook 52. Additionally, for the negated version of the code-vectors, Eq. 16 becomes:

$${E}_{q} = {\sum }_{n = 1}^{4} {q}^{′2} ( n ) + {\sum }_{n = 1}^{4} {uq}^{′2} ( n ) + 2 {\sum }_{n = 1}^{4} {q}^{′} ( n ) {uq}^{′} ( n ) \qquad Eq . 17$$

With the foregoing mathematical foundation, the codebook independent filter system 100 can be utilized to calculate the codebook independent quantization error, q′(n), and the codebook independent scaled codebook, uq′(n), for a given subframe.

By way of example, after the filter coefficients have been determined and the initial filter states set for the codebook independent filter system 100 (e.g., based on dq′(n) as described herein), the long term predictor 104 can compute a codebook independent pitch period vector ppv′(n). The independent pitch period vector ppv′(n) can be computed as a function of dq′(n) for a given input vector subframe, s(n). A combiner 112 computes sq′(n) by summing dq′(n) with the sp′(n) as provided by the short term predictor 106. The short term predictor 106 drives an input of a combiner 114 with the codebook independent short term predictor vector sp′(n). The combiner 114 sums sp′(n) with the short term noise feedback vector stnf′(n) from the short term noise feedback filter 108. A combiner 116 combines the input subsample s(n) with the output of the combiner 114 to provide the codebook independent unquantized short term residual vector v′(n).

A combiner 118 determines an unquantized excitation vector u′(n) by subtracting a codebook independent long-term signal component from v′(n). In the example of FIG. 3, the long-term noise feedback filter 110 computes a codebook independent long-term noise feedback vector ltnf′(n) as a function of a codebook independent quantization error vector q′(n). The codebook independent quantization error vector q′(n) corresponds to the unquantized excitation vector u′(n) for the codebook independent filter system 100. A combiner 120 sums ppv′(n) (e.g., which corresponds to the dq′(n)) with ltnf′(n) to provide the long-term signal component that the combiner 118 subtracts from v′(n) to produce u′(n). It will be appreciated that u′(n) also equals q′(n) since no scaled code-vector is provided to the filter system 100 during such computations. That is, the other combiners 122 and 124, depicted as dashed lines, are not required in the filter system 100 in the absence of the scaled code-vectors driving the filter.

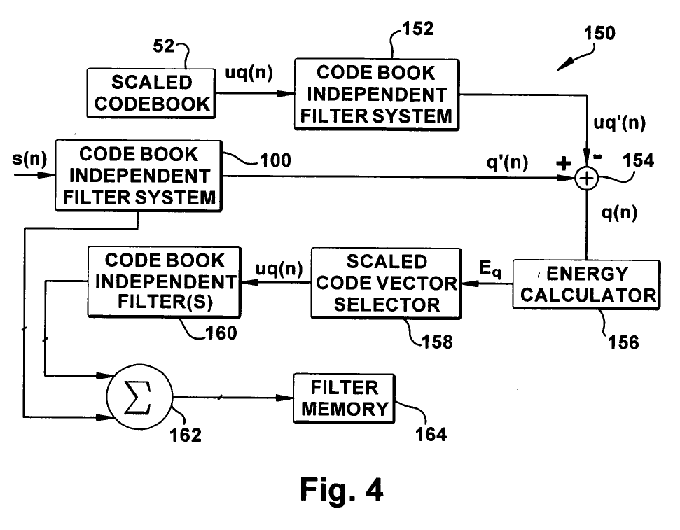

FIG. 4 depicts a block diagram for a codebook search 150 that can be employed to determine a winning scaled code-vector candidate from the gain scaled codebook 52. In FIG. 4, the input vector s(n) is applied to the codebook independent filter system 100 to determine the codebook independent quantization error vector q′(n), such as described above with respect to FIG. 3. Thus, the codebook independent filter system 100 provides means for calculating the codebook independent component of the quantization error vector q′(n), as described herein.

Additionally, the scaled code-vectors uq(n) from the scaled codebook 52 are filtered through the codebook independent filter 152 having a set of filter coefficients (e.g., as provided by Eqs. 12, 13 and 14) to provide a codebook independent scaled code-vector uq′(n) (e.g., as provided by Eq. 11). That is, the codebook independent filter system 152 provides means for determining a codebook independent quantized scaled code-vector based on driving a respective one of the plurality of code-vector candidates to the codebook independent filter. A combiner 154 calculates the quantization error vector q(n) for a given scaled code-vector uq(n) by subtracting uq′(n) from q′(n), such as according to Eq. 10. The combiner 154 thus provides means for determining the quantization error q(n) vector based on the codebook independent filter 152.

An energy calculator 156 computes the energy E_{q} for the computed quantization error vector q(n) for each of the respective code-vectors. As described herein, the winning the scaled code-vector candidate is the candidate that minimizes the energy of the quantization error vector q(n). Thus, a scaled code-vector selector 158 monitors the energy Eq for each of the scaled code-vectors and selects the winning candidate uq(n) accordingly. The filter memory is updated based on the winning code-vector candidate, as determined by the scaled codebook selector 158.

By way of further example, the winning code-vector candidate uq(n) for a given subframe is passed through a codebook independent filter 160. Even with uq(n) acting as the input to the filter 160, the filtering operations and calculations performed by such filter are codebook independent as the filter coefficients are not dependent on the scaled codebook. Instead, the codebook independent filters determine the set of filter memory states as function of the coefficients βᵢ′, αᵢ′ and αᵢ′ from Eqs. 12, 13 and 14 and as a function of uq(n). The codebook independent filter 100 also provides a set of filter states for the winning code-vector, including dq′(n), sq′(n), stnf′(n) and v′(n). A combiner 162 computes the updated filter memory states based on the set of filter states from the codebook independent filter 100 and the filter states from the codebook independent filter 160. The combiner 162 thus provides filter values for updating the filter memory states for the filter system. The updated filter memory states dq(n), sq(n), stnf(n), v(n) and for q(n) from the combiner 162 are then employed to update filter memory 164 for the respective filters.

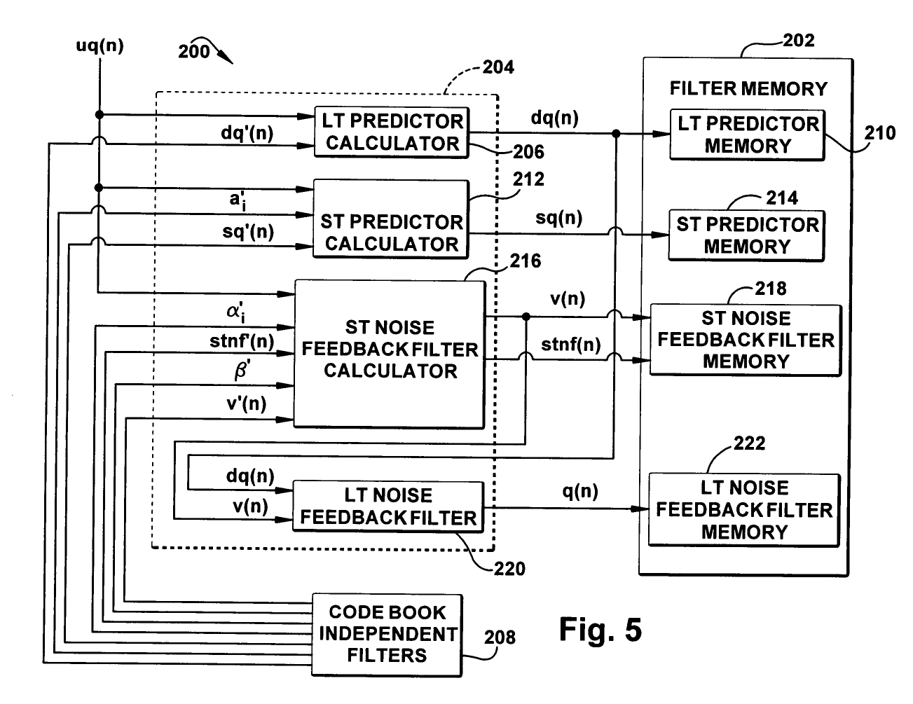

FIG. 5 depicts a further example of a block diagram of a system 200 for updating the filter memory 202 based on the winning code-vector according to an aspect of the present invention. The system 200 includes a filter calculator (e.g., corresponding to the combiner 164 of FIG. 4) 204 that calculates the updates for each of the respective filter states. In the example of FIG. 5, the filter calculator 202 includes a long term predictor calculator 206 that calculates an aggregate dq(n), such as follows:
dq(n)=dq′(n)+uq(n), for n=1, 2, 3, 4 Eq. 18
A codebook independent filter 208 (e.g., corresponding to the codebook independent filter system 100 in FIG. 4) provides the codebook independent filter memory states, including dq′(n) sq′(n), stnf′(n) and v′(n). The computed filter state dq(n) for the winning code-vector is utilized to update corresponding long term predictor memory 210.

A short term predictor calculator 212 calculates the sq(n) as a function of uq(n) and a set of short term filter coefficients aᵢ and the codebook independent quantized version of s(n), namely, sq′(n). The computation performed by the calculator 212 may be as follows:

$$sq ( n ) = {sq}^{′} ( n ) + {\sum }_{i = 1}^{n} {a}_{i}^{′} uq ( n - i + 1 ) , for n = 1 , 2 , 3 , 4 \qquad Eq . 19$$

The computed sq(n) is applied to update corresponding short term predictor memory 214.

The system also includes a short term noise feedback filter calculator 216. The calculator 216 computes stnf(n) and v(n) for the winning quantized scaled code-vector uq(n). For instance, the calculator 216 can include one component that computes stnf(n), such as follows:

$$stnf ( n ) = {stnf}^{′} ( n ) + {\sum }_{i = 2}^{n} {α}_{i}^{′} uq ( n - i + 1 ) , for n = 1 , 2 , 3 , 4 \qquad Eq . 20$$

The calculator 216 can also include another part that computes v(n), such as follows:

$$v ( n ) = {v}^{′} ( n ) + {\sum }_{i = 2}^{n} {β}_{i}^{′} uq ( n - i + 1 ) , for n = 1 , 2 , 3 , 4 \qquad Eq . 21$$

The calculator 216 utilizes the computed stnf(n) and v(n) memory states to update corresponding short term noise feedback filter memory 218.

The calculator 204 also includes a long term noise feedback calculator 220 that is programmed and/or configured to compute the memory state for the quantization error vector q(n) as a function of the computed dq(n) and v(n) values. For instance, by substituting from Eq. 7, it can be shown that:
q(n)=v(n)−dq(n)+λq(n−pp), for n=1, 2, 3, 4 Eq. 22

where
λ=pre-calculated long term noise feedback filter coefficient; and

pp=is the pitch period.

Thus from the foregoing Eqs., it is shown that the filter calculator 204 computes filter states by employing a set of equations that are codebook independent.

For the sake of simplicity, the foregoing search procedure has been described only for one subframe u(n) (e.g., corresponding to a vector of length 4). It will be understood that the procedure would be repeated for all the subframes in a given frame, with the aggregate procedure being repeated for each frame.

From the foregoing discussions and by way of comparison to the traditional approach of FIG. 2, it will be appreciated that the approach described herein provides a simplified procedure to quantize the excitation vector. In the implementation of a speech codec, for example, the approach described herein can reduce the computational complexity of this excitation quantization by up to approximately 80%, without affecting the perceived quality of speech.

As a further example, the core search loop contains only a multiply and accumulate operation (MAC) of order 4 of the form:
K(1)*C(1)+K(2)*C(2)+K(3)*C(3)+K(4)*C(4)

where
K(i) is the part independent of codebook entry, and

C(i) is the part dependent on the codebook entry.

Additionally, since the codebook 52 (in the foregoing example) consists of 16 independent code-vectors and their negated versions and the operation in the core search loop is of the form shown above, as a result the above MAC operation needs to be computed only once for a particular code-vector and its negated version. By following this approach, the filter memory save and restore process is avoided without incurring extra memory overheads as would be required by the traditional approach of FIG. 2.

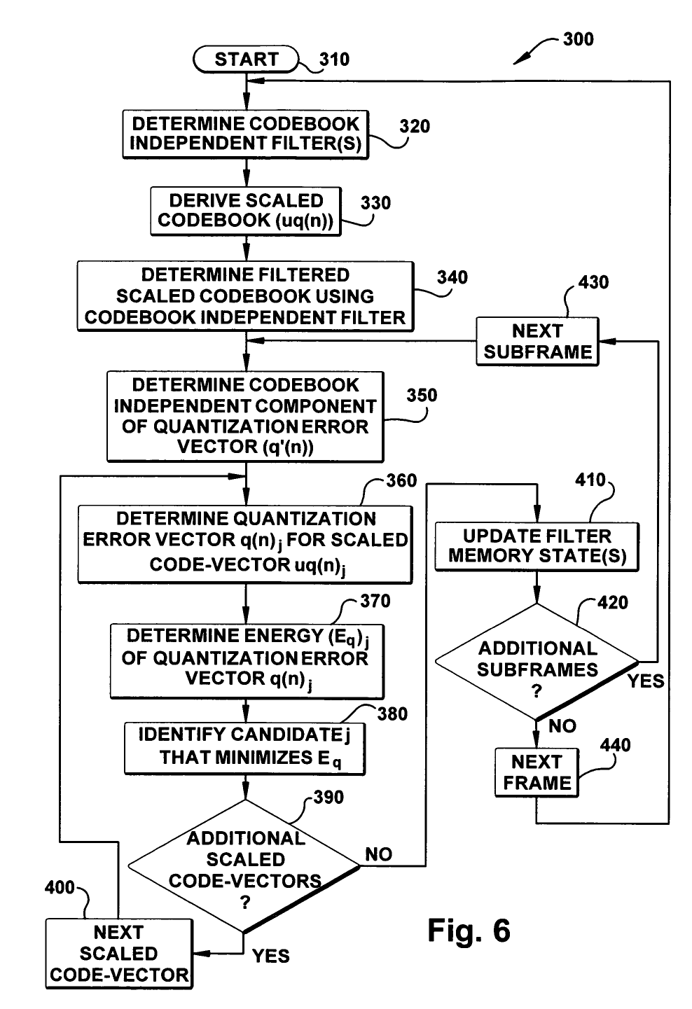

In view of the foregoing structural and functional features described above, an example method 300, in accordance with various aspects of the present invention, will be better appreciated with reference to FIG. 6. While, for purposes of simplicity of explanation, the method 300 of FIG. 6 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. The method of FIG. 6 can be implemented in hardware, or as computer executable instructions running on a processor (e.g., on a digital signal processor), or as a combination of hardware and software programmed and/or configured to implement the method. Example structures and means for performing one or more portions of the method of FIG. 6 are shown and described herein with respect to FIGS. 1, 3, 4, and 5.

The method 300 begins at 310, such as by setting variables and other parameters to their respective predetermined starting values. This can include providing or computing respective filter coefficients and initializing filter memory with starting filter memory states. At 320, a codebook independent filter system having one or more filters is determined. The codebook independent filter, for instance, can be determined by passing a quantized short-term residual vector and input vector for given subframe through the filter in the absence of any scaled code-vector from the codebook. At 330, a scaled codebook is derived, which includes a plurality of scaled code-vectors uq(n). The scaled codebook, for instance, can be derived by converting a log-gain codebook to a quantized gain-scaled codebook in the linear domain, such as by multiplying every code-vector by a predetermined (or computed) quantized gain factor.

At 340, a filtered version of the gain scaled codebook is determined using the codebook independent filter. The scaled code-vector can be determined by passing gain scaled code-vectors from the scaled codebook (from 330) through the codebook independent filter determined at 320. Thus, the filtered scaled codebook, includes code-vectors, uq′(n), which can be considered codebook independent since the filter used to derive the codebook does not vary as a function of the codebook. At 350, a codebook independent component of a quantization error vector, q′(n), is determined. For instance, q′(n) can be determined by passing an input subframe vector s(n) through the codebook independent filter (e.g., such as the filter 100 in FIG. 4).

The method continues to 360 in which a quantization error vector q(n)ⱼ (where j is a positive integer denoting a code-vector index from the scaled codebook) for a given scaled code-vector uq(n)ⱼ is determined (see, e.g., Eq. 10 and corresponding description herein). At 370, the energy (E_{q})ⱼ of the quantization error vector q(n)ⱼ is determined and, at 380, the code-vector candidate j that minimizes the energy thus far is identified.

At 390, a determination is made as to whether any additional scaled code-vectors exist in the codebook for which the portion of the method from 360-380 should be repeated. If additional code-vectors exist (YES), the method proceeds to 400. At 400, the next scaled code-vector is accessed for repeating 360-390. After no additional scaled code-vectors exist at 390 (NO), the method 300 proceeds to 410. With the transition from 390 to 410, the code-vector candidate identified at 380 as minimizing the energy (E_{q})ⱼ, is provided as the winning candidate. Thus, at 410, the filter memory states are updated for the winning code-vector candidate. For instance, the updating of filter memory can be implemented as shown and described with respect to FIG. 5.

At 420, a determination is made as to whether there are any additional subframes in the current frame. If additional subframes exist, the method proceeds to 430 in which the next subframe is accessed. From 430, the method returns to 350 to repeat the corresponding search process for the next subframe using the filtered scaled codebook and the codebook independent filter(s) from 330 and 350. If it is determined that no additional subframes remain at 420 (NO), the method proceeds from 420 to 440. At 440, the next frame is accessed and the method returns to 320 to repeat the method for the next frame.

What have been described above are examples of the present invention. It is, of course, not possible to describe every conceivable combination of components or methodologies for purposes of describing the present invention, but one of ordinary skill in the art will recognize that many further combinations and permutations of the present invention are possible. For example, while the examples shown and described herein relate to vector quantization of speech signals, the present invention is not limited to encoding speech. For instance, the present invention is equally applicable for compression of audio and video as well as for quantization of image signals to name a few. Accordingly, the present invention is intended to embrace all such alterations, modifications, and variations that fall within the spirit and scope of the appended claims.

What is claimed is:

1. A method for performing excitation quantization of an input signal using a vector quantization codebook having a plurality of code-vectors, the codebook being associated with a filter system, the method comprising:
determining filter states for the filter system independent of the codebook to define a codebook independent filter system;
determining a quantization error vector for at least a portion of the code-vectors in the codebook based at least in part on the codebook independent filter system;
selecting a winning code-vector from the codebook based on predetermined criteria that is functionally related to the determined quantization error vector; and
updating the filter memory states of the filter system using the selected winning code-vector.

2. The method of claim 1, wherein the determination of the quantization error vector further comprises:
applying the input signal to the codebook independent filter to determine a codebook independent quantization error vector;
applying the at least a portion of code-vectors from the codebook to a predetermined codebook independent filter system having at least one pre-computed codebook independent filter coefficient to determine a codebook independent code-vector for each of the at least a portion of code-vectors from the codebook; and
combining the codebook independent quantization error vector and the codebook independent code-vector to provide the quantization error for the at least a portion of the code-vectors.

3. The method of claim 2, wherein each of the codebook independent code-vectors are determined as a function of a respective code-vector from the codebook and as a function of providing the respective code-vector through the predetermined codebook independent filter system.

4. The method of claim 1, wherein the determination of filter states for the codebook independent filter system further comprises passing a codebook independent residual signal through the filter system; and
the method further comprises updating the memory of the filter system based on filter memory states that result from passing the codebook independent residual signal through the filter system to provide the codebook independent filter system.

5. The method of claim 4, wherein the input signal is divided into frames, each frame having a plurality of subframes, the codebook independent residual signal being passed through the filter system once per frame, the input signal that is applied to the codebook independent filter comprising a subframe of the input signal, such that a corresponding winning code-vector is selected for each subframe.

6. The method of claim 1, further comprising calculating an energy for each of the determined quantization error vectors, the winning code-vector from the codebook being selected based on the which of the at least a portion of the code-vectors minimizes the energy of the determined quantization error vector.

7. The method of claim 1, wherein the input signal comprises an unquantized speech signal vector that is divided into frames having a plurality of subframes, each subframe including at least two samples.

8. The method of claim 1, wherein the codebook independent filter system is a first codebook independent filter system having a first set of filter states, the method further comprising:
applying the winning code-vector to a second codebook independent filter having at least one codebook independent filter coefficient to determine a second set filter states for the codebook independent filter system; and
calculating filter states for the filter system based on at least a portion of the first set of filter states and the second set of filter states, the calculated filter states being used to update the filter memory states.

9. The method of claim 1, further comprising calculating a new set of filter states as a function of the winning code-vector and filter states associated with the codebook independent filter system.

10. A system for performing excitation quantization of an input signal, comprising:
means for determining a codebook independent filter having filter states that are independent of an associated scaled codebook;
means for determining a winning code-vector candidate from a plurality of code-vector candidates in the codebook based on predetermined criteria that evaluates the code-vector candidates using the codebook independent filter; and
means for updating filter memory with filter states determined based on the winning code-vector candidate.

11. The system of claim 10, further comprising means for determining a quantization error vector based on the codebook independent filter, the means for updating employing the quantization error for the winning code-vector candidate to perform the updating of the filter memory.

12. The system of claim 11, wherein the means for determining a quantization error vector further comprises:
means for determining a codebook independent quantized scaled code-vector based on driving a respective one of the plurality of code-vector candidates to the codebook independent filter;
means for calculating a codebook independent component of the quantization error vector; and
means for combining the codebook independent quantized scaled code-vector and the codebook independent component of the quantization error vector to provide the quantization error vector.

13. The system of claim 11, further comprising:
means for calculating an energy of the quantization error vector for each of the plurality of code-vector candidates; and
means for selecting the winning code-vector candidate according to which of the plurality of code-vector candidates minimizes the energy of the quantization error vector.

14. The system of claim 10, wherein the codebook independent filter has a first set of filter states, the system further comprising:
means for determining a second set filter states for the codebook independent filter system resulting from applying the winning code-vector candidate through the codebook independent filter system; and
means for combining the first set of filter states and the second set of filter states to provide the filter states that are used by the means for updating to update the filter memory.

15. The system of claim 14, wherein the means for determining further comprises means for calculating each filter state in the second set of filter states from respective codebook independent filter update equations that vary as a function of the winning code-vector candidate and are independent of the scaled codebook.

16. The system of claim 10, further comprising means for calculating filter coefficients of a starting filter system independently from the associated codebook based on passing a codebook independent quantized short-term prediction residual signal through the starting filter system, the codebook independent filter being generated from the starting filter system.

17. The system of claim 16, wherein the input signal is divided into frames, each frame having a plurality of subframes, the codebook independent quantized short-term prediction residual signal being passed through the starting filter system once per frame, the input signal that is applied to the codebook independent filter comprising a subframe of the input signal, such that a winning code-vector is selected for each subframe.

18. A system comprising:
a filter system associated with a scaled codebook that has a plurality of code-vectors, the filter system having filter parameters that define respective filter states in corresponding filter memory; and
a codebook search having a first component that configures the filter system independently of the codebook for a given input signal and updates the filter memory to define a codebook independent filter system having corresponding codebook independent filter states, the codebook search having a second component that updates the filter memory with a second set of filter states based on a winning code-vector that is selected from the scaled codebook to substantially minimize energy of a quantization error vector of the filter system, at least a portion of the quantization error vector being determined as a function of the codebook independent filter system.

19. The system of claim 18, further comprising:
a combiner that determines the quantization error vector for at least a substantial portion of the plurality of code-vectors by aggregating a codebook independent quantization error vector, which is generated by applying the input signal to the codebook independent filter system, with a codebook independent code-vector for each of the at least a portion of code-vectors from the codebook, each of the codebook independent code-vector being determined by driving the codebook independent filter system with at least a portion of the code-vectors from the scaled codebook; and
a calculator that determines the energy for the at least a substantial portion of the plurality of code-vectors, which energy is employed to select the winning code-vector.

20. The system of claim 18, further comprising a combiner that determines the second set of filter states by aggregating the first set of filter states of the codebook independent filter system with respective filter state components determined as a function of the winning code-vector and filter coefficients of the codebook independent filter system.
